(19) United States
(12) Patent Application Publication
(10) Pub. No.: US 2022/0262565 A1
(43) Pub. Date: Aug. 18, 2022

(54) CAPACITOR HOUSING AND LINK CAPACITOR WITH A HOUSING OF SAID KIND

(71) Applicant: JHEECO E-DRIVE AG, Eschen (LI)

(72) Inventors: Katja STENGERT, Lienz (CH); Martin BERKMANN, Andelsbuch (AT)

(21) Appl. No.: 17/630,490

(22) PCT Filed: Jul. 21, 2020
(86) PCT No.: PCT/EP2020/070575

§ 371 Date: Jan. 26, 2022

(30) Foreign Application Priority Data
Jul. 26, 2019 (DE) DE 10 2019 120 33

(51) Int. Cl. H01G 2/10

(52) U.S. Cl. CPC H01G 2/106

(57) ABSTRACT

The invention relates to a capacitor housing for electric circuits. The capacitor housing has a closed collar, into which busbars extend, to guarantee a clean assembly and subsequent filling with resin. The collar has pairs of through openings on the upper side and the lower side for the passage of a sleeve part through each, an upper and lower sleeve part each contacting as a terminal device one of the busbars and clamping same between the end faces of the sleeve parts. The invention also relates to a link capacitor with a housing of this kind.

The invention relates to a capacitor housing for electrical circuits, in particular for link capacitors, which are used in power converters.

Link capacitors have the objective of smoothing occurring voltage peaks. For this purpose, they are connected in parallel between the positive and negative busbars or the positive and negative battery poles.

In power converters for converting direct current into three-phase alternating current, power modules (current switches for high currents based on semiconductors) are used. These are preferably connected to the link circuit, in this case the link capacitor, both positively and negatively. Consequently, the following terminals must be provided for a link capacitor: 2 battery terminals and 3 terminals per power module.

CN104934223 (Wuxi 2015) shows an exemplary capacitor for an electric vehicle in which battery and power module terminals are located on the same (open) side of the capacitor housing.

Busbars and power modules can be located on opposite sides of the capacitor housing. The problem arises of providing electrical terminals on different sides of the capacitor housing.

In the prior art, this is solved, for example, by routing busbars out from the housing-open side and around the housing to provide a second terminal there, cf. e.g. EP3210219 (BYD 2017). The fabrication of such busbars is costly. At the same time, such detours cause increased inductance.

Another approach is chosen by JP2015088633A (Nichicon 2013) by forming a protrusion in a capacitor housing, on which a contacting lug is contacted via screw and nut. A disadvantage is that the capacitor housing must be accessible from above for this purpose. Furthermore, the capacitor housing is not sealed until the contact has been screwed, i.e. the capacitor housing can only be encapsulated with a resin afterwards (as is usual for capacitors).

The object of the present invention is to overcome or at least minimize the disadvantages of the prior art. In particular, a capacitor housing is sought which allows local separation of electrical terminals and proper filling with resin.

For this purpose, the present invention provides a capacitor housing according to claim 1. In detail, this is a capacitor housing for electrical circuits, in particular for link capacitors of converter circuits, wherein the capacitor housing has a closed collar into which busbars extend. The collar has pairs of through-openings on the upper side and lower side for the passage of a sleeve part in each case. One upper and one lower sleeve part each contact one of the busbars as a terminal device and clamp the busbars between the end faces of the sleeve parts.

The closed collar of the capacitor housing has the advantage of collecting a resin filled into the housing and preventing leakage of the resin. As a result, no additional steps or precautionary or hygienic measures need to be implemented during the manufacture of a capacitor with such a housing to ensure a clean or dirt-free environment and fabrication. This saves costs and reduces errors in, for example, electrical contacts and the installation of the capacitor in the housing.

Furthermore, due to the sleeve parts, no additional supports need to be formed in the collar or housing for the busbars. This simplifies the manufacture of the housing and allows flexible configuration of the busbars to be used.

Preferably, capacitors are arranged in the capacitor housing, which are electrically connected to the busbars, and the housing with the capacitors is filled with resin. This configuration relates to a preferred use or application of the housing.

In a further preferred configuration, the upper and lower sleeve parts of a terminal device are not in direct contact with each other and are each retained in the through-opening by crimping or press-fitting. The corresponding parts, such as sleeve parts and through-opening, are simple in structure and easy to manufacture. In particular, the fastening of the sleeve parts in the openings does not require any additional fastening means.

Alternatively or additionally, the upper and lower sleeve parts of a terminal device are formed as push-in sleeves and pressed into each other by means of elastic deformation. This configuration of the sleeve parts allows them to be easily fastened together. In this case, a part of one (e.g. upper) sleeve part, such as a hollow cylinder bar, can be inserted into the other (e.g. lower) sleeve part and fastened by positive locking.

In order to be able to insert longer contact plugs into the sleeve parts and thus into the collar, the busbars can have through-openings which are arranged coaxially with the through-openings of the collar. This allows additional or alternative terminal connections from a battery/conductor to the housing, e.g. in the form of a screw/nut connection.

Preferably, the through-openings of the busbars are configured such that the upper and/or lower sleeve part can be pushed through and/or screwed into them. This can be realized, for example, by a corresponding form or a correspondingly large diameter of the opening relative to the sleeve part. Additionally or alternatively, the opening can have an internal thread into which the sleeve part can be screwed.

Likewise, it has been found to be preferred if the busbars are arranged one above the other and each have a lead-through opening in which one of the sleeve parts that attaches or clamps another busbar is or can be arranged. Primarily, the lead-through opening is intended to enable the sleeve part to come into direct contact with the other busbar and thus clamp it with the aid of the other sleeve part.

Preferably, the sleeve parts for external terminals are formed as a plug-in contact or as a screw contact with an internal thread. Thus, for example, screws could be screwed into the internal thread and fastened and serve as a terminal to a battery/conductor. In the case of the plug-in contacts, for example, terminals with bayonet catches are feasible, which can be inserted and fixed in the sleeve part.

In order to keep the collar sealed, especially when pouring a resin, the sleeve parts preferably have sealing devices, especially in the form of washers or sealing rings, on a flange part.

The capacitor housing, in particular the collar, is preferably integrally formed and made of plastic. This simplifies manufacture and reduces costs.

The present invention also provides a link capacitor with a capacitor housing according to the invention, in which one or more capacitors and one or more busbars are arranged and fixed.

In addition, the following preferred features of the capacitor housing are significant that were not mentioned in the sub-claims:

In a further preferred configuration, one or more insulation plates are arranged between the busbars for electrical insulation. The busbars located in the capacitor housing are separated from one another by insulation inserts (insulation plates) or corresponding coatings.

Preferably, a section from a busbar seals an open side of the capacitor housing and has through-openings for filling a resin into the capacitor housing.

Likewise, the sleeve parts can be electrically conductive; i.e. that the entire sleeve part e.g. is formed of metal or only a part of the sleeve part which is electrically connected at least to the clamped busbar. For this purpose, the end face and the inner circumference of the sleeve parts could be provided with an electrically conductive coating.

The Figures described below refer to preferred embodiments of the capacitor housing according to the invention as well as of the link capacitor according to the invention, wherein these Figures do not serve as a limitation but substantially serve to illustrate the invention. Elements from different Figures but having the same reference signs are identical; therefore, the description of an element from one Figure is also valid for elements from other Figures having the same designation or number.

It is shown by

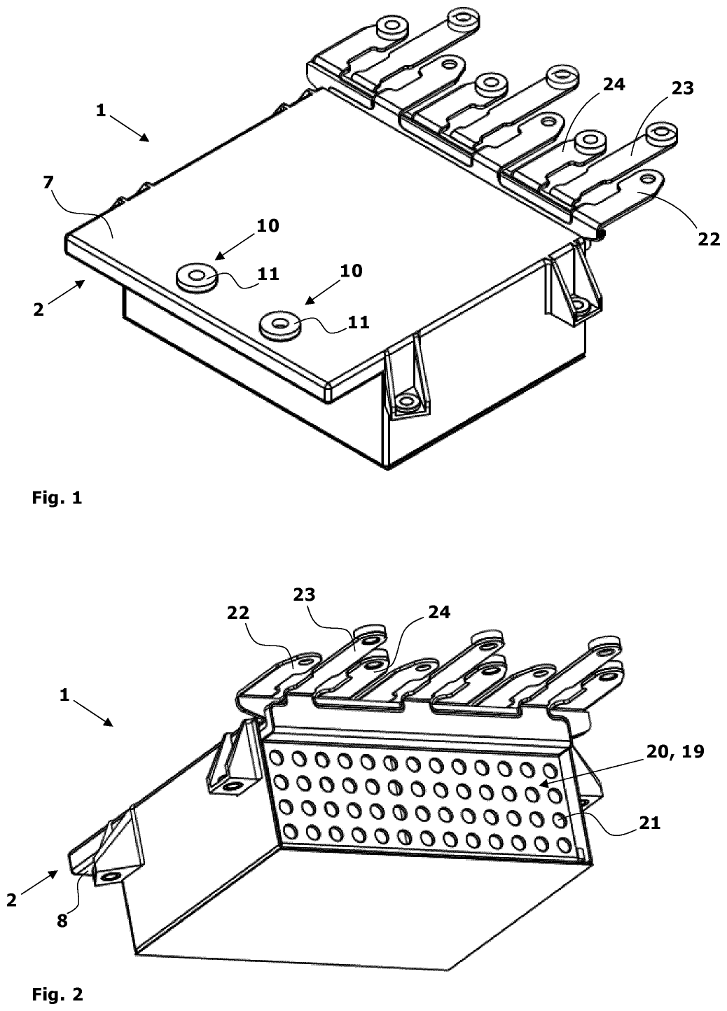

FIG. 1 a perspective view of a capacitor housing according to a preferred embodiment of the invention;

FIG. 2 a further perspective view of the capacitor housing from FIG. 1;

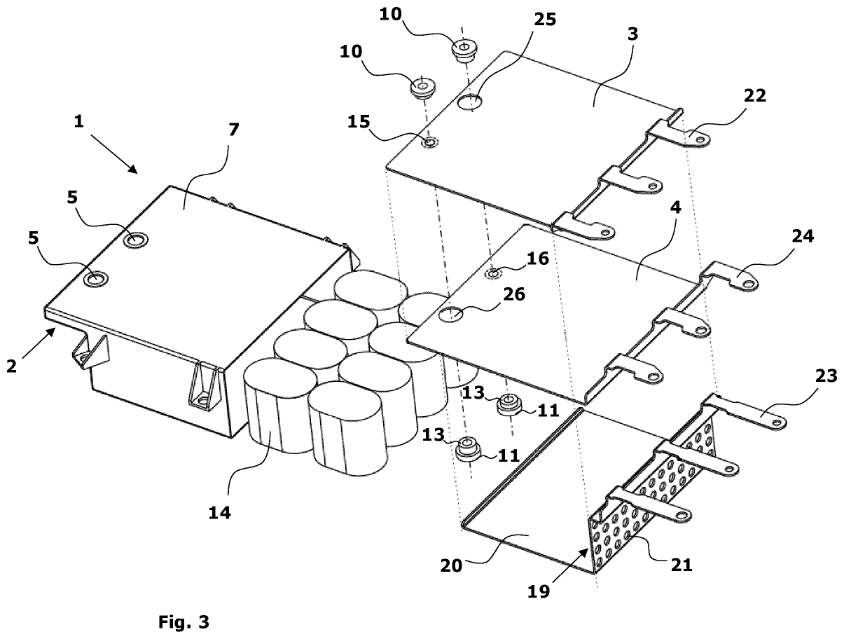

FIG. 3 an exploded view of the capacitor housing from FIG. 1;

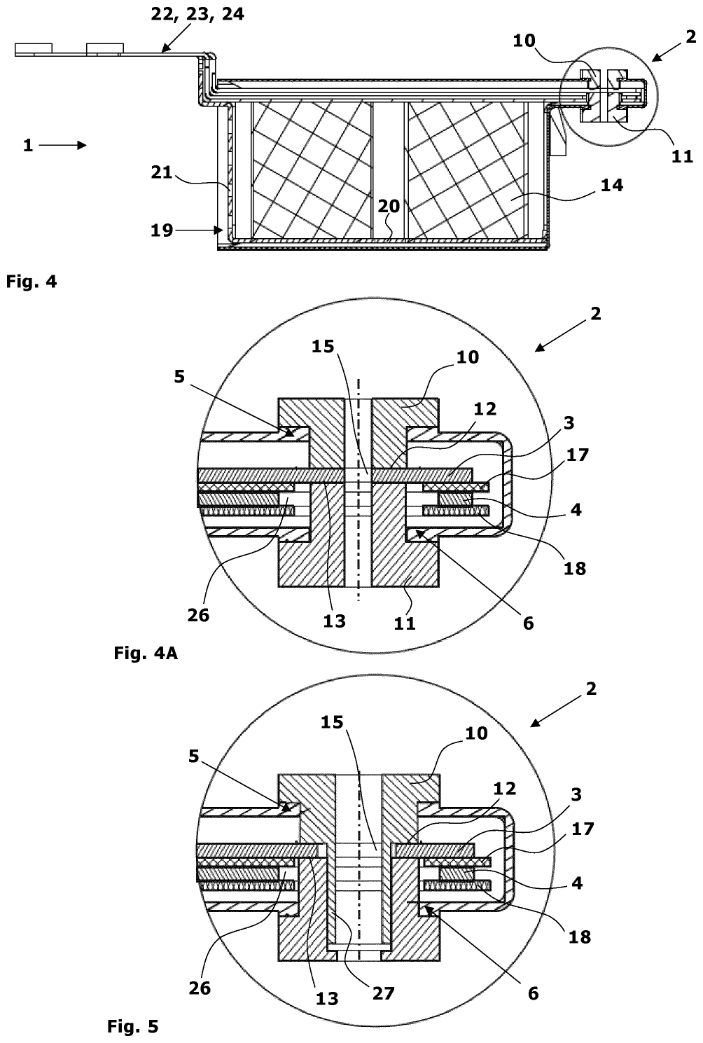

FIG. 4 a cross-sectional view of the capacitor housing from FIG. 1;

FIG. 4A a magnified section from the cross-sectional view of FIG. 4, showing a collar of the capacitor housing according to the invention;

FIG. 5 a cross-sectional view illustrating a further collar of the capacitor housing according to a further embodiment of the invention; and

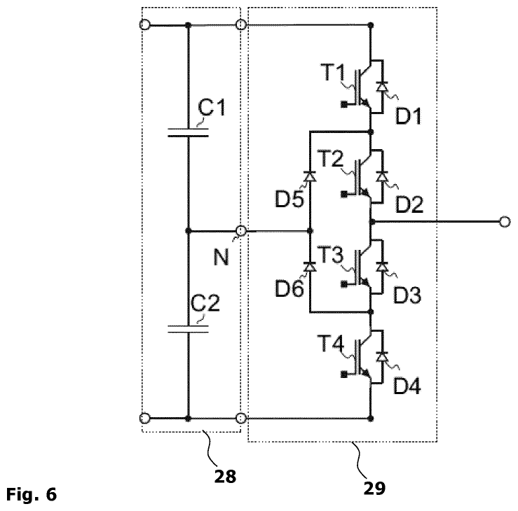

FIG. 6 a circuit diagram of a DC/AC converter with a capacitor circuit and a converter circuit for one phase.

In the embodiments, a capacitor for a 3-level converter with three phases, i.e. three power modules, is shown, wherein a capacitor housing 1 according to the invention is used. For this reason, the capacitor windings 14 are connected to form two logical capacitors C1 and C2 connected in series (cf. FIG. 6). Three taps are made via the three busbars 3, 4, 20: a positive tap, a negative tap and a tap between the two logic capacitors (terminal N). A corresponding circuit diagram for a phase/power module is shown in FIG. 6. The busbars and the capacitor windings are shown schematically in the Figures and can vary in their shape/structure and position/arrangement depending on the terminal and/or arrangement concept.

FIG. 1 shows a perspective view of a capacitor housing 1 according to a preferred embodiment of the invention. The housing is preferably configured cuboidally and in one piece and has a collar 2 in which two (or more) terminal devices 10 are arranged. The collar forms a cuboidal extension of one side of the capacitor housing 1. In this case, the upper side 7 of the collar is flush or flat with the upper side of the housing 1. The two terminal devices 10 serve as terminals for the positive and negative conductors of, for example, an external battery (not shown). Both terminal devices 10 are each formed by an upper sleeve part 10 and a lower sleeve part 11 (not visible). Both sleeve parts 10 and 11 extend through an opening at the upper side 7 and at the lower side of the collar 2 into the interior of the collar and each clamp a busbar (not visible) between them. On the side of the capacitor housing 1 opposite the collar, a positive, a neutral (or intermediate voltage) and a negative contact lug 22, 23, 24, are each formed three times. The contact lugs 22, 23, 24 extend parallel to and spaced apart from each other and lie on a plane parallel to the upper side of the capacitor housing 1. A triplet of contact lugs 22, 23, 24 forms the terminal for a power module or converter of one phase. All three triplets can thus each supply an inverter, allowing a 3-phase alternating current to be generated. Two mounting devices are formed on each of two opposing side surfaces of the capacitor housing 1, each of which has a through hole and can be attached to a frame or other housing by means of a screw.

FIG. 2 shows another perspective view of the capacitor housing 1 from FIG. 1. The side surface of the capacitor housing 1 opposite the collar 2, below the three triplets of contact lugs 22, 23, 24, is open and covered by a section 19 of an intermediate voltage busbar 20 (terminal N). Section 19 is flat, rectangular, and perpendicular to the inside of the walls of the capacitor housing 1. In addition, a plurality of through-openings 21 are formed in the section 19 to allow resin to be poured into the interior of the capacitor housing 1.

FIG. 3 shows an exploded view of the capacitor housing 1 from FIG. 1. Two through-openings 5 for the upper sleeve parts 10 are formed on the upper side 7 of the housing 1, in particular the collar 2. The through-openings 5 have the same diameter and can preferably have an annular web on the upper side 7. Inside the capacitor housing 1, eight capacitors 14 or capacitor windings are arranged, as well as a positive busbar 3, a negative busbar 4 and an intermediate voltage bar 20. The capacitors are arranged in two rows. In each row, the corresponding four capacitors 14 are electrically connected in parallel. While the capacitors 14 of one row are connected with their positive pole (bottom side) to the intermediate voltage bar 20, the capacitors 14 of the other row are connected with their negative pole (bottom side) to the intermediate voltage bar 20. The upper side or positive pole of one capacitor row 14 is in turn connected to the positive busbar 3 and the upper side or negative pole of the other capacitor row 14 is connected to the negative busbar 4. The positive and negative busbars 3 and 4 are preferably arranged one above the other, in particular within the collar 2. Both busbars 3, 4 each have a through-opening 15, 16 and a lead-through opening 25, 26. In addition, the busbars 3, 4 are electrically insulated from each other by means of a coating and/or insulation plates or layers (not shown). In addition, the lead-through openings 25 and 26 are configured such that, in the case of electrically conductive sleeve parts 10, 11, these are electrically insulated from the corresponding busbars 3, 4. This can be achieved by the lead-through openings 25, 26 having a diameter configured large enough to prevent a voltage flashover (in particular when filled with resin) between sleeve part 10, 11 and busbar 3, 4. Additionally or alternatively, the lead-through openings 25, 26 can have an insulation coating or ring covering the inner wall of the opening and its edge upper and lower sides. One terminal device consisting of upper and lower sleeve parts 10, 11 clamps the positive busbar 3 and the other terminal device clamps the negative busbar 4 inside the collar 2. In doing so, the corresponding busbars 3, 4 are clamped between the end faces 12 (not visible) and 13 of the sleeve parts 10, 11. Preferably, the sleeve parts 10, 11 of the one terminal device as well as the through-openings 5 and 6 and the through-opening 15 of the positive busbar 3 and the through-opening 26 of the negative busbar 4 have a common axis. The same applies to the other terminal device as well as the through-openings 5 and 6 and the through-opening 16 of the negative busbar 4 and the through-opening 25 of the positive busbar 3, which have a common axis. Both axes are arranged parallel to each other and spaced apart from the edge of the respective bar 3, 4 or collar by the same distance.

FIG. 4 shows a cross-sectional view of the capacitor housing 1 of FIG. 1 with the capacitors 14 arranged therein in two rows, the corresponding busbars 3, 4 and 20 as well as the collar 2 and the sleeve parts 10 and 11.

FIG. 4A shows a magnified section from the cross-sectional view of FIG. 4, depicting a collar 2 of the capacitor housing 1 according to the invention. In the collar 2, the positive busbar 3, a first insulation plate 17, the negative busbar 4, and a second insulation plate 18 are arranged in parallel and one above the other. The upper side and the lower side of the collar 2 each have a through-opening 5, 6 in which the upper and lower sleeve parts 10, 11 are inserted, respectively. The upper and lower sleeve parts 10, 11 are each formed with a flange-shaped head, a cylindrical body, and a straight through-hole from the head to the opposite end of the body. The sleeve parts 10, 11 are pressed or screwed into the corresponding opening 5, 6 and exert a holding force (frictional connection) on the corresponding busbar 3, 4 with their respective end faces 12, 13. In this case, the sleeve parts 10, 11 are configured and/or inserted such that the contact surfaces with the through-opening 5, 6 and the busbar 3, 4 are tight and prevent leakage of the resin. Instead of the through-hole of the sleeve parts 10, 11, the sleeve parts can alternatively have a blind hole for a connector and in particular be electrically conductive.

FIG. 5 shows a cross-sectional view depicting a further collar 2 of the capacitor housing 1 according to a further embodiment of the present invention. Here, the sleeve parts 10 and 11 differ from those shown in FIG. 4A. The upper sleeve part 10 has a hollow cylindrical web 27 as an extension at the end or at the end face 13, which extends through the through-opening 15 and is inserted into the lower sleeve part 11. This results in a form fit between the upper sleeve parts 10, in particular its web 27, and the lower sleeve part 11, in particular the inner wall of its through-hole. If the diameter of the through-opening of the upper sleeve part 10 remains the same as in FIG. 4A, the through-opening 15 and the inner diameter of the through-opening (at least partially or sectionally) of the lower sleeve part 11 are comparatively larger.

FIG. 6 shows a circuit diagram of a DC/AC converter with a capacitor circuit 28 and a converter circuit 29 for one phase. The capacitor circuit 28 can be formed by a capacitor housing according to the invention, e.g. as shown in FIG. 1, with capacitors and busbars. Furthermore, not only one but three converter circuits 29 can be connected via the three triplet terminals or contact lugs as described in FIG. 1. The capacitor circuit 28 has a positive and a negative DC terminal on the left side, for example to a battery, and three terminals on the right side. Two of these terminals are electrically connected to the two DC terminals respectively; the third terminal forms the intermediate voltage or terminal N.

### LIST OF REFERENCE SIGNS

1 capacitor housing
2 collar
3 busbar, positive
4 busbar, negative
5 through-opening, on the upper side of the collar
6 through-opening, on the lower side of the collar
7 upper side of the collar
8 lower side of the collar
9 terminal device
10 upper sleeve part
11 lower sleeve part
12 end face of the upper sleeve part
13 end face of the lower sleeve part
14 capacitor
15 through-opening of the positive busbar
16 through-opening of the negative busbar
17 first insulation plate
18 second insulation plate
19 section of the intermediate voltage bar
20 busbar, intermediate voltage
21 through-openings, at the intermediate voltage busbar
22 contact lug, positive
23 contact lug, neutral
24 contact lug, negative
25 lead-through opening
26 lead-through opening
27 hollow cylindrical web of the upper sleeve part
28 capacitor circuit
29 converter circuit

1. Capacitor housing for electric circuits, wherein the capacitor housing has a closed collar, into which busbars extend,
wherein the collar has pairs of through openings on the upper side and the lower side for the passage of a sleeve part through each,
wherein an upper and lower sleeve part each contacting as a terminal device one of the busbars and clamping same between the end faces of the sleeve parts.

2. Capacitor housing according to claim 1, wherein capacitors are arranged in the capacitor housing, which are electrically connected to the busbars, and the housing with the capacitors is filled with resin.

3. Capacitor housing according to claim 1, wherein the upper and lower sleeve parts of a terminal device are not in direct contact with each other and are each retained in the through-opening by crimping.

4. Capacitor housing according to claim 1, wherein the upper and lower sleeve parts of a terminal device are formed as plug-in sleeves and are pressed into one another by means of elastic deformation.

5. Capacitor housing according to claim 1, wherein the busbars have through-openings arranged coaxially with the through-openings of the collar.

6. Capacitor housing according to claim 5, wherein the through-openings of the busbars are formed such that the upper and/or upper sleeve part can be inserted and/or screwed through.

7. Capacitor housing according to claim 5, wherein the busbars are arranged one above the other and each have a lead-through opening in which one of the sleeve parts contacting the other busbar is arranged without contact.

8. Capacitor housing according to claim 1, wherein the sleeve parts for external terminals are formed as a plug-in contact or as a screw contact with an internal thread.

9. Capacitor housing according to claim 1, wherein the sleeve parts have sealing devices, in particular in the form of washers or sealing rings, on a flange part.

10. Capacitor housing according to claim 1, wherein the capacitor housing, in particular the collar, is formed in one piece and of plastic.

11. Link capacitor comprising a capacitor housing according to claim 1.

12. Capacitor housing according to claim 2, wherein the upper and lower sleeve parts of a terminal device are not in direct contact with each other and are each retained in the through-opening by crimping.

13. Capacitor housing according to claim 12, wherein the upper and lower sleeve parts of a terminal device are formed as plug-in sleeves and are pressed into one another by means of elastic deformation.

14. Capacitor housing according to claim 13, wherein the busbars have through-openings arranged coaxially with the through-openings of the collar.

15. Capacitor housing according to claim 14, wherein the through-openings of the busbars are formed such that the upper and/or upper sleeve part can be inserted and/or screwed through.

16. Capacitor housing according to claim 15, wherein the busbars are arranged one above the other and each have a lead-through opening in which one of the sleeve parts contacting the other busbar is arranged without contact.

17. Capacitor housing according to claim 16, wherein the sleeve parts for external terminals are formed as a plug-in contact or as a screw contact with an internal thread.

18. Capacitor housing according to claim 17, wherein the sleeve parts have sealing devices, in particular in the form of washers or sealing rings, on a flange part.

19. Capacitor housing according to claim 18, wherein the capacitor housing, in particular the collar, is formed in one piece and of plastic.
